(19) United States
(12) Patent Application Publication
(10) Pub. No.: US 2008/0142483 A1
(43) Pub. Date: Jun. 19, 2008

(54) MULTI-STEP DEP-ETCH-DEP HIGH DENSITY PLASMA CHEMICAL VAPOR DEPOSITION PROCESSES FOR DIELECTRIC GAPFILLS

(75) Inventors: Zhong Qiang Hua, Saratoga, CA (US); Rionard Purnawan, Mountain View, CA (US); Jason Thomas Bloking, Mountain View, CA (US); Anchuan Wang, Sunnyvale, CA (US); Young S. Lee, San Jose, CA (US); Ellie Y. Yieh, San Jose, CA (US)

Correspondence Address: TOWNSEND AND TOWNSEND AND CREW LLP / AMAT, TWO EMBARCADERO CENTER, EIGHTH FLOOR, SAN FRANCISCO, CA, 94111-3834, US

(73) Assignee: Applied Materials, Inc., Santa Clara, CA (US)

(21) Appl. No.: 11/947,619

(22) Filed: Nov. 29, 2007

Related U.S. Application Data
(60) Provisional application No. 60/869,066, filed on Dec. 7, 2006.

(51) Int. Cl. B44C 1/22

(52) U.S. Cl. 216/67

(57) ABSTRACT

A method of forming a dielectric material in a substrate gap using a high-density plasma is described. The method may include depositing a first portion of the dielectric material into the gap with the high-density plasma. The deposition may form a protruding structure that at least partially blocks the deposition of the dielectric material into the gap. The first portion of dielectric material is exposed to an etchant that includes reactive species from a mixture that includes NH₃ and NF₃. The etchant forms a solid reaction product with the protruding structure, and the solid reaction product may be removed from the substrate. A final portion of the dielectric material may be deposited in the gap with the high-density plasma.

### CROSS-REFERENCES TO RELATED APPLICATIONS

This application claims the benefit of U.S. Provisional Application No. 60/869,066, filed Dec. 7, 2006. This application is also related to the U.S. patent application filed on the same day as the present application having Attorney Docket No. A11598-01/T76810, titled “Multi-step Dep-Etch-Dep High Aspect Ratio Process for Dielectric Gapfills.” The entire contents of both application are herein incorporated by reference for all purposes.

### BACKGROUND OF THE INVENTION

Gaps, trenches, and other structures are now routinely fabricated at sub-100 nm scales in semiconductor devices. This continued miniaturization on the horizontal surface of the substrate wafer reduces the widths of the device features more than their heights, resulting in an increased height-to-width ratio (the aspect ratio) for the features. Gaps and trenches with aspect ratios of greater than 5:1 are typical, and aspect ratios of greater than 8:1, 10:1, and 12:1 or more are possible with the continued reduction in gap widths to 70 nm, 45 nm, and smaller.

Smaller trenches with higher aspect ratios are more difficult to fill with dielectric material. Conventional silicon oxide deposition processes like plasma-enhanced CVD (PECVD) with TEOS/oxygen and TEOS/ozone, and even high-density plasma CVD, tend to deposit oxide more rapidly around the top of the gap than the bottom. Eventually, the top oxide growth can seal the gap before the oxide has completely filled the bottom and sides; a condition known as “breadloafing” that can leave a void in the middle of the gap.

Breadloafing can be reduced by increasing the conformality of the oxide layer that is deposited in the gap. One technique to increase the conformality of the deposited oxide is reducing the oxide deposition rate. Reduced deposition rates give the oxide materials time to be distributed along the sidewalls and bottom of the gap, increasing conformality. However, a lower deposition rate increases the deposition time, which decreases the fabrication process efficiency.

Another solution to the breadloafing problem has been to use precursors and pressures that promote a more flowlike and conformal deposition of the oxide in the gap. In many of these techniques the sidewalls and bottom of the gap are filled more evenly with substantially less overgrowth at the top of the gap. These depositions have been particularly effective when gap has a taper angle (i.e., the angle between the sidewalls and bottom of the gap) of about 87° or less. However, when the sidewalls become more parallel such that the taper angle is more than about 87° (e.g., about 88°, about 89°, about 90°) it becomes more difficult for the sidewalls to come together without voids or a seam forming in the middle of the gap fill.

In some instances, these seams can be “healed” with a reflow process. For example, if the oxide can maintain a viscous flow at elevated temperatures, it may be possible to flow oxide into the seam or void. However, reflow processes often become less effective with decreased gap widths, and may not be practical where the temperature for a reasonable reflow rate exceeds the thermal budget of the device. Thus, there remains a need for new systems and methods to reduce or eliminate voids and seams in dielectric gapfills.

### BRIEF SUMMARY OF THE INVENTION

Embodiments of the invention include methods of forming a dielectric material in a substrate gap using a high-density plasma. The methods may include the steps of depositing a first portion of the dielectric material into the gap with the high-density plasma, and exposing the first portion of dielectric material to an etchant comprising reactive species from a mixture that includes NH₃ and NF₃. The methods may also include the step of depositing a final portion of the dielectric material in the gap with the high-density plasma.

Embodiments of the invention also include additional methods of forming a dielectric material in a substrate gap using a high-density plasma. The methods may include the step of depositing a first portion of the dielectric material into the gap with the high-density plasma, where the deposition forms a protruding structure that at least partially blocks the deposition of the dielectric material into the gap. The methods may also include exposing the first portion of dielectric material to an etchant comprising reactive species from a mixture that includes NH₃ and NF₃, where the etchant forms a solid reaction product with the protruding structure. The methods may still further include the steps of removing the solid reaction product from the substrate, and depositing a final portion of the dielectric material in the gap with the high-density plasma.

Embodiments of the invention still further include methods of forming a dielectric material on a substrate using a high-density plasma. The methods may include depositing a first portion of the dielectric material into a gap on the substrate with the high-density plasma in a HDPCVD chamber. The deposition may form a protruding structure that at least partially blocks the deposition of the dielectric material into the gap. The substrate may then be transferred to an etching chamber and exposing the first portion of dielectric material to an etchant comprising reactive species from a mixture that includes NH₃ and NF₃. The etchant forms a solid reaction product with the protruding structure which may be removed from the substrate. The substrate may be transferred back to the HDPCVD chamber and depositing a final portion of the dielectric material in the gap with the high-density plasma.

Additional embodiments and features are set forth in part in the description that follows, and in part will become apparent to those skilled in the art upon examination of the specification or may be learned by the practice of the invention. The features and advantages of the invention may be realized and attained by means of the instrumentalities, combinations, and methods described in the specification.

### BRIEF DESCRIPTION OF THE DRAWINGS

FIG. 1 is a flowchart showing steps in a dep-etch-dep process for depositing a dielectric material in a gap according to embodiments of the invention;

FIG. 2 is a flowchart showing steps in a high aspect ratio process for depositing a dielectric material in a gap according to embodiments of the invention;

FIG. 3 is a flowchart showing steps in a high density plasma process for depositing a dielectric material in a gap according to embodiments of the invention;

FIGS. 4A-D show cross-sectional views of a gap as a dielectric material is deposited in the gap with a high aspect ratio process according to embodiments of the invention;

FIGS. 5A-D show cross-sectional views of a gap as a dielectric material is deposited in the gap with a high-density plasma process according to embodiments of the invention;

FIG. 6A shows a simplified representation of a HARP SACVD apparatus according to embodiments of the invention;

FIG. 6B shows a simplified diagram of a gas panel and supply lines in relation to a HARP SACVD deposition chamber according to embodiments of the invention;

FIG. 7A shows a simplified a high density plasma chemical vapor deposition system for depositing a dielectric material in a gap according to embodiments of the invention; and

FIG. 7B shows a simplified schematic cross section of a gas ring that may be used in conjunction with the exemplary CVD processing chamber of FIG. 7A according to embodiments of the invention.

### DETAILED DESCRIPTION OF THE INVENTION

Methods and systems for filling substrate gaps and trenches with dielectric materials are described. These methods include filling gaps using high-density plasma (HDP), and also methods of filling the gaps with sub-atmospheric chemical vapor deposition processes (SACVD) including high-aspect ratio processes (HARP). In these methods, a first portion of dielectric material is deposited into the gap, followed by the exposure of the deposited dielectric to a mixture that includes ammonia and nitrogen trifluoride that has been activated in a plasma. The activated plasma includes reactive species that react with a portion of the dielectric material to create reaction products that may be removed from the substrate. Then, an additional portion of dielectric material may be deposited into the gap to create a gapfill with substantially no voids or weak seams. These methods may be referred to as “dep-etch-dep” methods where the dielectric gapfill is interrupted by an etch step that removes some of the deposited dielectric so that additional dielectric can be deposited without the formation of voids or weak seams. While the term “dep-etch-dep” implies a three step process to fill the gap or trench, the deposition and etching cycles may be repeated two, three, four, etc., times before the gapfill is completed.

The goal of the etch step(s) is to create a gap or trench topography that can produce a gapfill that is substantially free of voids and weak seams. The way the dielectric layer is etched, however, may vary depending on whether HDP or HARP was used to deposit the dielectric material. In HDP depositions, breadloafing is a significant problem, and the etchant addresses it by reacting with the protrusions of dielectric material that can partially block the gap or trench opening. The solid reaction products formed by the etchant may be removed by, for example, sublimating the solids into gases that are whisked away by the exhaust system of the substrate chamber.

In HARP depositions, the high chamber pressure (e.g., hundreds of Torr) usually produces a more conformal dielectric film, making breadloafing less of a concern. However, HARP depositions are more problematic when the sidewalls of a narrow gap or trench go from being slanted (e.g., the sidewalls and bottom of the gap form an angle that is less than 87°) to being substantially parallel (e.g., about 89° to about 91°). For substantially parallel sidewalls, the deposited dielectric film converging in from the sidewalls and bottom of the trench can leave a weak seam around the middle of the gapfill. To avoid this problem, the etchant flows into the open center of the gap and reacts with the dielectric material at the exposed surfaces of the deposited film. When the reaction products are removed, the etching process reshapes the trench opening to have more slanted sidewalls that are more favorable for a seam free dielectric gapfill.

As noted above, for both types of gapfill processes the etching step includes exposing the dielectric to reactive species in an activated gas mixture that includes ammonia (NH₃) and nitrogen trifluoride (NF₃). The mixture may also include additional gases such as nitrogen (N₂), hydrogen (H₂), and/or noble gases like helium, argon, etc., among other gases. The mixture is activated by being formed into a plasma that creates reactive species, such as ammonia radicals and ions from the NH₃ and fluorine radicals from the NF₃. These and other species react with the dielectric material to form solid reaction products (e.g., salts) that typically vaporize at low temperatures (e.g., about 100° C. or less). For example, when the dielectric is a silicon oxide (SiOₓ) the reactive species in the etchant react with the oxide and are believed to form an ammonium fluorosilicate salt such as ammonium hexafluorosilicate (NH₄)₂.SiF₆. These salts are then removed by heating the substrate above the sublimation temperature.

The ammonia/nitrogen trifluoride etchant is highly selective, and will etch silicon oxide faster than silicon nitride. For example, the SiOₓ:SiN etch rate ratio may be up to about 12 or more. This property of the etchant can be used advantageously to etch away portions of an oxide film without as much concern about overetching an underlying silicon nitride layer (e.g., a SiN liner). For example, when etching a SiOₓ protrusion blocking the opening of a gap, the etching can proceed past the normal endpoint without causing significant damage to an underlying silicon nitride barrier layer. In another example, the upper portion of an oxide film formed on the sidewalls of a gap can be overetched to form more inwardly sloping sidewalls from the top to the bottom of the gap.

### Exemplary Dep-Etch-Dep Processes

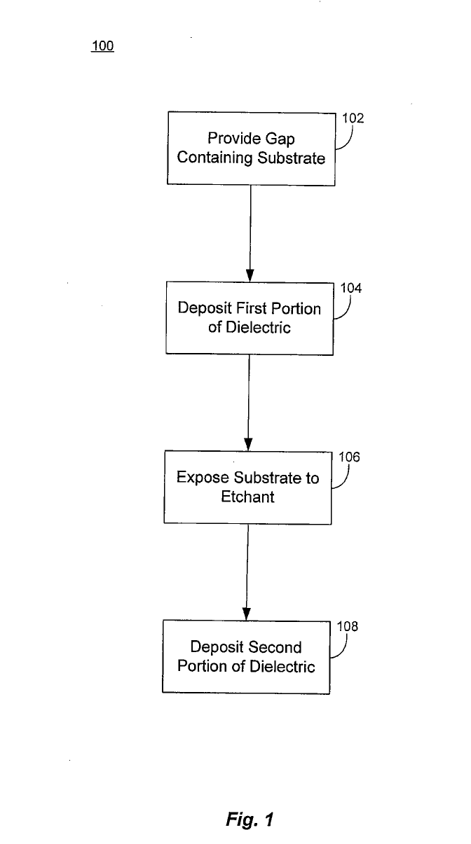

Referring now to FIG. 1, steps in a dep-etch-dep process 100 for depositing a dielectric material in a gap according to embodiments of the invention is shown. The process 100 is generic to the type of dielectric deposition method used. The process 100 may start by providing a substrate that contains a gap 102. The substrate may be, for example, a standard sized circular silicon wafer (e.g., 200 mm, 300 mm diameter) that has gaps and trenches formed into the silicon itself and additional layers of material (including dielectric layers) formed on the silicon surface. Often, the gaps and trenches define a part of the structure of a circuit element (e.g., diode, transistor, gate, interconnect, etc.) that has already been formed on the substrate.

The process 100 may also include depositing a first portion of dielectric material on the substrate 104. The dielectric deposition process may use an HDP process, a SACVD process such as HARP, or PECVD process such as a plasma-enhanced TEOS and oxygen or TEOS and ozone deposition, among other dielectric deposition processes. The deposited dielectric may include a silicon oxide such an undoped silica glass (USG) layer, or a doped silica layer such as a phosphorous silicate glass (PSG), borosilicate glass (BSG), or borophosphosilicate glass (BPSG) layer. Additional examples of deposited dielectric materials may include silicon nitride (SiN) and silicon oxy-nitride (SiON).

Following the deposition, the substrate may be exposed to the etchant 106. Before or during the etchant exposure, the substrate temperature may be reduced to a temperature below the vaporization/sublimation temperature of the etchant's reaction products (e.g., about 25° C. to about 75° C.). As noted above, the etchant may include reactive species that are formed by the activation of a gas mixture that includes NH₃ and NF₃. Activation of the gas mixture may include generating a plasma from the gas that excites and ionizes and/or dissociates some of the NH₃ and NF₃ molecules into the reactive species. The plasma may be generated remotely from the substrate chamber(s) where the dielectric deposition and exposure to the etchant occur. In these instances, the reactive species formed in the remote plasma may be supplied by an external conduit to the substrate chamber via a showerhead or nozzles. The remote plasma generator power may be about 500 Watts.

The flow rate for the NH₃ may be about 10 sccm to 1000 sccm (e.g., about 70 sccm, about 400 sccm). The NF₃ may have a flow rate of about 1 sccm to about 100 sccm (e.g., about 50 sccm). In some instances, an inert gas such as helium may also form part of the etchant gas mixture, and may have a flow rate ranging from about 100 sccm to about 1000 sccm (e.g., about 300 sccm). The relative flow rates of the NH₃ and NF₃ may favor a NH₃ rich gas mixture. For example, the NH₃ flow rate may be about twice or more than the NF₃ flow rate (i.e., a NH₃/NF₃ flow rate ratio of about 2 or more). Embodiments also include higher NH₃/NF₃ flow rate ratios, such as about 3:1 or more, about 4:1 or more, about 5:1 or more, about 6:1 or more, about 7:1 or more, about 8:1 or more, etc. Embodiments further include having the NH₃/NF₃ flow rate ratio range from greater than about 1:1 to about 20:1. The pressure of the etchant in the substrate chamber during the etching process may range from about 2 Torr to about 10 Torr.

When the substrate is exposed to the etchant, the reactive species in the etchant may react with a portion of the deposited dielectric to form the reaction products. When the substrate's temperature is below the melting or sublimation points of the reaction products, solid products are formed. These products may then be removed by raising the temperature of the substrate above the vaporization temperature of the reaction products. For example, solid reaction products formed from the reaction of the reactive species in the etch with silicon oxide dielectric are often vaporized and removed by raising the substrate temperature to about 100° C. or more, which is above the sublimation temperature of the products.

After the etchant reaction products have been removed, the topography of the gap is usually improved for the deposition of a second portion of dielectric material on the substrate 108. In some instances, the deposition of the second portion is the final deposition needed to completely fill the gap. In additional instances, a subsequent etchant exposure and dielectric deposition is performed before the gapfill is complete. In still more additional instances, several etch-dep cycles are repeated before the gapfill is complete.

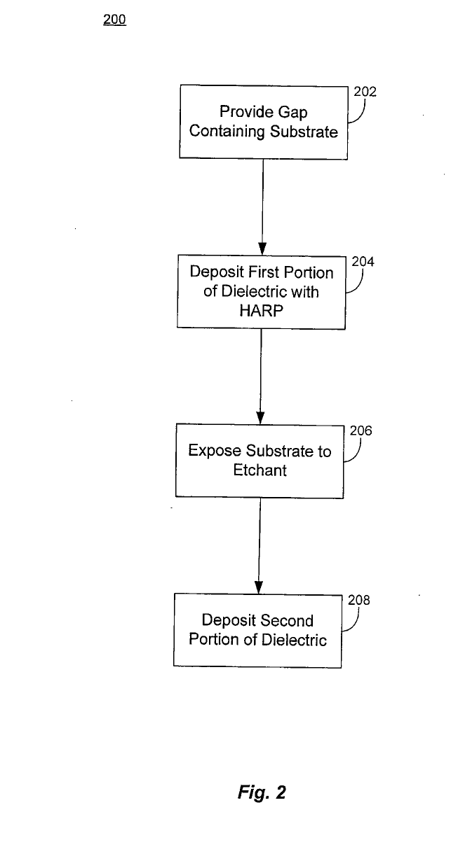

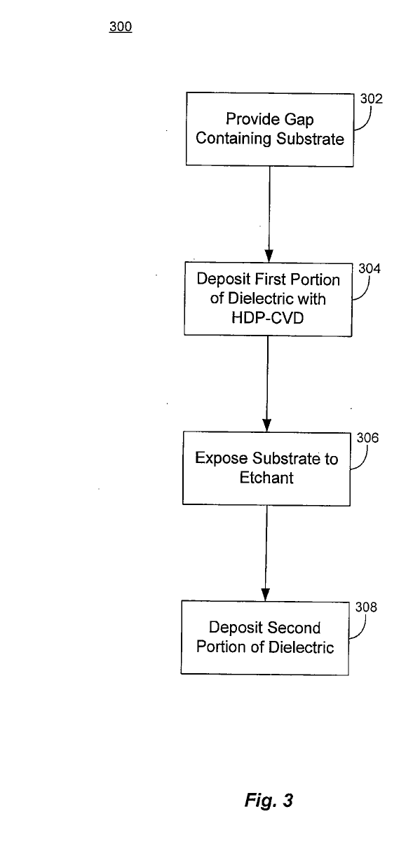

FIGS. 2 and 3 outline the steps of dep-etch-dep processes that are more specific to using HARP and HDP, respectively, for the dielectric depositions. In HARP, the deposition process may include varying the dielectric deposition rate during the deposition by, for example, varying the flow rate ratio of a silicon containing precursor to an oxidizer precursor. For example, the deposition may originally start out at a lower rate to enhance the conformality of the deposited dielectric by allowing the film to have more time to distribute uniformly over the edges of the gap. The deposition rate may then be increased (continuously or in stepwise increments) to fill the gap quickly, increasing the deposition efficiency. Additional details about HARP dielectric depositions are described in U.S. Pat. No. 6,905,940 to Ingle et al, issued Jun. 14, 2005, and titled “METHOD OF USING TEOS RAMP-UP DURING TEOS/OZONE CVD FOR IMPROVED GAPFILL” the entire contents of which are herein incorporated by reference for all purposes.

In HDP-CVD dielectric depositions, the dielectric is being simultaneously deposited and sputtered by a high-density of low energy ions (often Ar⁺) contacting the substrate surface. These ions can simultaneously sputter the dielectric film being deposited by the deposition gases to different areas of the deposition surface. This can distribute the deposited film more evenly over the deposition surface and allow the film to be deposited at lower temperature. As a result, the deposited dielectric is often more dense and has fewer topographical irregularities than depositions of the same material with, for example, PECVD. However, irregularities such as protrusions in the gap are not completely prevented by the sputtering when deposition gases like TEOS and ozone are used to form the dielectric. The protrusions tend to form with more frequency in high aspect ratio gaps where fewer sputtering ions reach the materials in the gap. Moreover, even small protrusions can create substantial blockages in a high aspect ratio gap because the gap width is usually very narrow (e.g., about 70 nm or less).

FIG. 2 is a flowchart showing steps in HARP for depositing a dielectric material in a gap according to embodiments of the invention. The process 200 includes providing a substrate containing at least one gap 202 to a HARP deposition chamber. A first portion of the dielectric may be deposited with a HARP process 204. For example, if the dielectric layer is an USG layer, the HARP process may include flowing a silicon containing precursor (e.g., silane, TEOS) and an oxidizing precursor (e.g., oxygen (O₂), ozone (O₃)) into a chamber. The total chamber pressure is relatively high (e.g., about 400 to about 700 Torr, about 600 Torr), and inert gases such as helium, nitrogen (N₂) may be added to carry the deposition precursors and maintain the chamber pressure. The substrate temperature may be about 300° C. to about 600° C. (e.g., about 540° C.) during the deposition. Exemplary deposition conditions for a silicon oxide layer deposited with HARP are listed in Table 1:

TABLE 1
Exemplary Deposition Conditions for HARP formed SiOx Film

| | | TEOS | | | | | | |
|---|---|---|---|---|---|---|---|---|
| | Deposition | Flow | He Flow | N₂ Flow | O₃ Flow | | | |
| Film | Time | Rate | Rate | Rate | Rate | Pressure | Temp | Spacing |
| Thickness | (sec) | (mgm) | (sccm) | (sccm) | (sccm) | (Torr) | (° C.) | (mils) |
| 500 Å | 175 | 1350 | 13500 | 28000 | 18000 | 600 | 540 | 300 |

After the first portion of the dielectric film is deposited by HARP, it may be exposed to the etchant 206. Prior to or during this exposure, the substrate may be cooled from the HARP deposition temperature to a temperature of about 100° C. or less to facilitate the formation of solid reaction products. As noted above, the etchant may include reactive species formed from a mixture that includes NH₃ and NF₃ gases. Exemplary conditions for the etchant exposure following the deposition of the first portion of the silicon oxide layer with HARP are listed in Table 2:

TABLE 2
Exemplary Etchant Exposure Conditions

| | | | | NH₃ | | | | |
|---|---|---|---|---|---|---|---|---|
| Target | Exposure | | NF₃ Flow | Flow | He Flow | | | |
| Amount | Time | RF Power | Rate | Rate | Rate | Temp | Spacing | Etch Rate |
| Etched | (sec) | (W) | (sccm) | (sccm) | (sccm) | (° C.) | (mils) | (A/min) |
| 200 Å | 15 | 40 | 35 | 70 | 300 | 35 | 700 | 800 |

As noted above, the initially deposited HARP dielectric layer may be substantially conformal with the shape of the gap, with little or no breadloafing. When the etchant reaches this conformal layer, it reacts with the exposed surfaces of the dielectric in the gap and forms reaction products. When the reaction products are removed, for example by heating the substrate to sublimate the solid products, the new gap defined at least in part by the etched dielectric film may have a different taper than the original gap. For example, the original sidewalls may be substantially parallel, forming an angle of about 89° to about 91° between the sidewalls and bottom side of the gap. After the etch however, the remaining dielectric can define a new gap profile having sidewalls that are more tapered (e.g., slanted inward from the top to the bottom of the trench). The angle between the sidewalls and bottom side of the gap may now be, for example, about 87° or less.

Following the etchant exposure, a second portion of the HARP dielectric may be formed in the gap 208. As noted above, this portion of the dielectric may be deposited in a gap with a more tapered profile (e.g., about 87° or less) than the original gap. The increased slant between the sidewalls and bottom of the gap allows the second dielectric fill to converge from the sidewalls and bottom of the gap with a reduced probability of forming a weak seam in the middle of the gapfill.

Referring now to FIG. 3, a flowchart showing steps in a high density plasma (HDP) process for depositing a dielectric material in a gap according to embodiments of the invention is shown. The process 300 includes providing a substrate containing at least one gap 302. A first portion of a dielectric layer is deposited on the gap 304 using a HDP process. As noted above, the dielectric deposition with HDP is prone to breadloafing where protrusions form around the top of the gap and partially (sometimes completely) block the opening.

In process 300, the protrusions formed in the initial HDP dielectric deposition step are removed by first exposing the substrate to the etchant 306. As the etchant reacts with the protrusions, they form reaction products that may be subsequently removed by, for example, heating the substrate wafer above the vaporization/sublimation temperature of the reaction products. With the protrusion removed, a subsequent HDP deposition of a second portion of the dielectric 308 may be done to partially or completely fill the gap with the dielectric. Table 3 lists some exemplary parameter ranges for an HDP dep-etch-dep process:

TABLE 3
Exemplary Parameter Ranges for HDP Dep-Etch-Dep Process

| NH₃/NF₃ | Pressure | BRF | IHC(Temp) |
|---|---|---|---|
| Ratio | (Torr) | Power (W) | (Torr) |
| 0-20 | 2-10 | 3000-1200 | 0.5-3 |

### Exemplary Trench Cross-Sections

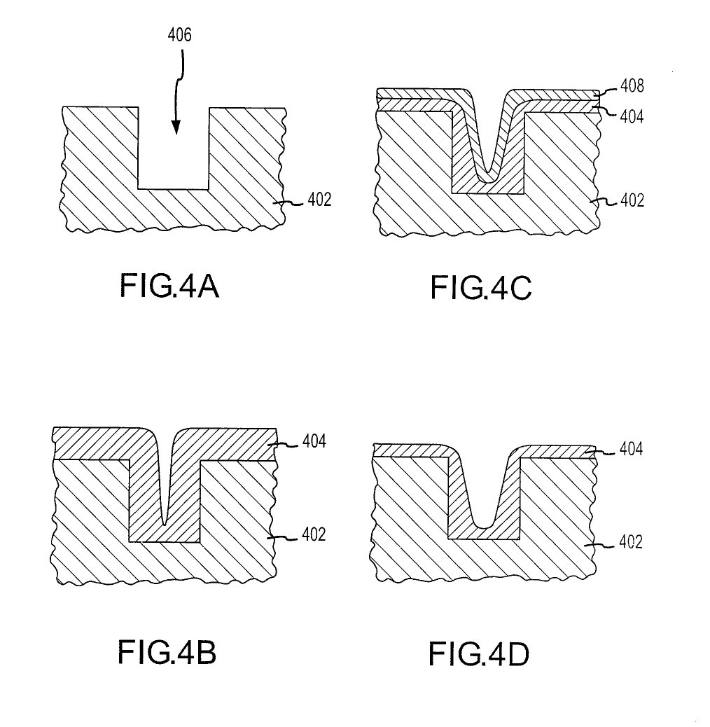

FIGS. 4A-D show the formation and etching of a first portion of a dielectric layer in a gap of a substrate using HARP. FIG. 4A shows the gap 406 formed in the substrate 402 before the first portion of the dielectric material has been deposited. The gap 406 has sidewalls that are substantially parallel (i.e., form a substantially 90° angle) with the bottom of the gap.

FIG. 4B shows the substrate 402 after the first portion of the dielectric layer 404 has been deposited in the gap 406. The layer 404 is substantially conformal with the sidewalls and bottom of the gap 406. In this example, the dielectric deposition was stopped before the gap was completely filled, which leaves a long narrow cavity in the center of the gap 406. If the deposition continued until the gap 406 was completely filled, it would have been likely that a weak seam would have developed in the center of the gap.

FIG. 4C shows the solid reaction product 408 formed where the dielectric layer 404 is exposed to an etchant. As noted above, reactive species in the etchant react with the dielectric material at the exposed surface of layer 404 to form solid reaction products 408. When these reaction products are removed by vaporization or sublimation, the profile of the open space in gap 406 changes from the originally parallel profile to a more tapered profile. FIG. 4D shows the tapered profile in the gap 406 that is formed by the remaining dielectric layer 404 that lines the gap. The new tapered profile with more slanted sidewalls makes it easier to form one or more additional portions of the dielectric layer such that a void or weak seam is avoided in the center of the filled gap 406.

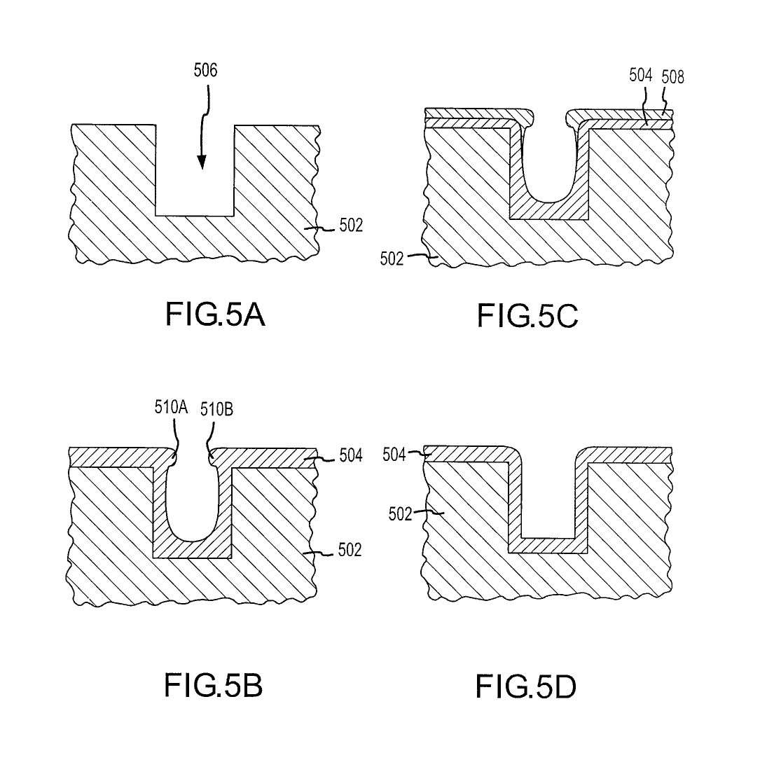

Referring now to FIGS. 5A-D, the formation and etching of a first portion of a dielectric layer in a gap of a substrate using and HDP-CVD process is shown. FIG. 5A shows the gap 506 formed in the substrate 502 before the first portion of the dielectric material has been deposited.

Into this gap 506 is deposited a first portion of the dielectric layer 504 by an HDP-CVD process, as shown in FIG. 5B. The layer 504 is not as conformal with the sidewalls and bottom of the gap 506, and includes protrusions 510A & B that partially block the top opening in the gap 506. In this example, the dielectric deposition was stopped before the gap was completely filled, which leaves a empty space in the center of the gap 506. If the deposition continued until the gap 506 was completely filled, it would have been likely that a significant void would have developed in the center of the gap.

FIG. 5C shows the solid reaction product 508 formed where the dielectric layer 504 is exposed to an etchant. As noted above, reactive species in the etchant react with the dielectric material at the exposed surface of layer 504 to form the solid reaction products 508. When these reaction products are removed by vaporization or sublimation, the protrusions 510A&B caused by the breadloafing around the top of the gap are removed, and the remaining dielectric 504 is much more conformal with the underlying gap, as shown in FIG. 5D. The new conformal profile without the protrusions 510A&B makes it easier to form one or more additional portions of the dielectric layer such that a void is avoided in the center of the filled gap 506.

### Exemplary Process Systems

A. HARP System

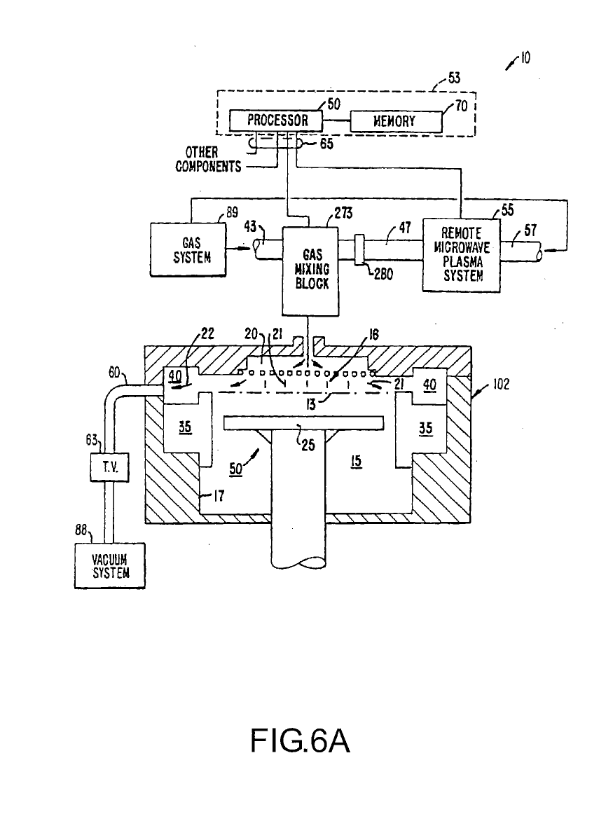

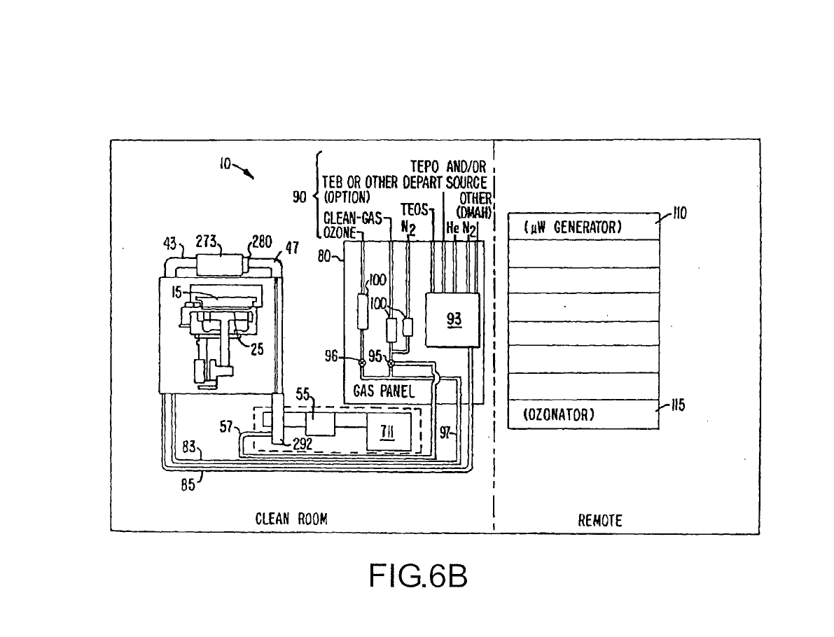

FIGS. 6A and 6B show simplified representations of a HARP SACVD system that may be used to conduct embodiments of the dep-etch-dep methods described above. Aspects of this exemplary system are incorporated into commercially available HARP SACVD systems, such as models from the PRECISION™, CENTURA™, and PRODUCER™ CVD system lines from APPLIED MATERIALS, INC. of Santa Clara, Calif.

FIG. 6A shows a chemical vapor deposition (“CVD”) system 10 that may be suitable for performing the sub-atmospheric CVD (“SACVD”) dielectric deposition and etching steps according to embodiments of the invention. The system 10 is capable of performing multiple-step processes on a substrate wafer without removing the substrate from the chamber or breaking vacuum. Some of the components of exemplary system 10 shown in FIG. 6A include a vacuum chamber 15 that receives process and other gases from a gas delivery system 89, a vacuum system 88, a remote microwave plasma system 55, and a control system 53.

The CVD apparatus 10 includes an enclosure assembly 102 housing a vacuum chamber 15 with a gas reaction area 16. A gas distribution plate 20 is provided above the gas reaction area 16 for dispersing reactive gases and other gases, such as purge gases, through perforated holes in the gas distribution plate 20 to a substrate wafer (not shown) that rests on a vertically movable heater 25 (also referred to as a wafer support pedestal). The heater 25 can be controllably moved between a lower position, where a wafer can be loaded or unloaded, for example, and a processing position closely adjacent to the gas distribution plate 20, indicated by a dashed line 13, or to other positions for other purposes, such as for an etch or cleaning process. A center board (not shown) includes sensors for providing information on the position of the wafer.

The heater 25 includes an electrically resistive heating element (not shown) enclosed in a ceramic. The ceramic protects the heating element from potentially corrosive chamber environments and allows the heater to attain temperatures up to about 800° C. In an exemplary embodiment, surfaces of the heater 25 exposed to the vacuum chamber 15 may be made of a ceramic material, such as aluminum oxide (Al₂O₃ or alumina) or aluminum nitride.

Reactive and carrier gases are supplied through the supply line 43 into a gas mixing box (also called a gas mixing block) 273, where they are preferably mixed together and delivered to the gas distribution plate 20. The gas mixing box 273 is preferably a dual input mixing block coupled to a process gas supply line 43 and to a cleaning/etch gas conduit 47. A valve 280 operates to admit or seal gas or plasma from the gas conduit 47 to the gas mixing block 273. The gas conduit 47 receives gases from an integral remote microwave plasma system 55, which has an inlet 57 for receiving input gases. During deposition processing, gas supplied to the plate 20 is vented toward the wafer surface (as indicated by arrows 21), where it may be uniformly distributed radially across the wafer surface, typically in a laminar flow.

Purging gas may be delivered into the vacuum chamber 15 from the plate 20 and/or an inlet port or tube (not shown) through the bottom wall of enclosure assembly 102. The purging gas flows upward from the inlet port past the heater 25 and to an annular pumping channel 40. An exhaust system then exhausts the gas (as indicated by arrows 22) into the annular pumping channel 40 and through an exhaust line 60 to a vacuum system 88, which includes a vacuum pump (not shown). Exhaust gases and entrained particles are drawn from the annular pumping channel 40 through the exhaust line 60 at a rate controlled by a throttle valve system 63.

The remote microwave plasma system 55 can produce a plasma for selected applications, such as chamber cleaning or etching native oxide or residue from a process wafer. Plasma species produced in the remote plasma system 55 from precursors supplied via the input line 57 are sent via the conduit 47 for dispersion through the plate 20 to the vacuum chamber 15. Precursor gases for a cleaning application may include fluorine, chlorine, and other reactive elements. The remote microwave plasma system 55 also may be adapted to deposit plasma-enhanced CVD films by selecting appropriate deposition precursor gases for use in the remote microwave plasma system 55.

The system controller 53 controls activities and operating parameters of the deposition system. The processor 50 executes system control software, such as a computer program stored in a memory 70 coupled to the processor 50. Preferably, the memory 70 may be a hard disk drive, but of course the memory 70 may be other kinds of memory, such as read-only memory or flash memory. In addition to a hard disk drive (e.g., memory 70), the CVD apparatus 10 in a preferred embodiment includes a floppy disk drive and a card rack (not shown).

The processor 50 operates according to system control software, which includes sets of instructions that dictate the timing, mixture of gases, chamber pressure, chamber temperature, microwave power levels, susceptor position, and other parameters of a particular process. Other computer programs such as those stored on other memory including, for example, a floppy disk or another computer program product inserted in a disk drive or other appropriate drive, may also be used to operate the processor 50 to configure the CVD system 10 into various apparatuses.

The processor 50 has a card rack (not shown) that contains a single-board computer, analog and digital input/output boards, interface boards and stepper motor controller boards. Various parts of the CVD system 10 conform to the Versa Modular European (VME) standard which defines board, card cage, and connector dimensions and types. The VME standard also defines the bus structure having a 16-bit data bus and 24-bit address bus.

FIG. 6B shows illustrates a general overview of an embodiment of the exemplary CVD system 10 in relation to a gas supply panel 80 located in a clean room. As discussed above, the CVD system 10 includes a chamber 15 with a heater 25, a gas mixing box 273 with inputs from an inlet tube 43 and a conduit 47, and remote microwave plasma system 55 with input line 57. As mentioned above, the gas mixing box 273 is for mixing and injecting deposition gas(es) and clean gas(es) or other gas(es) through the inlet tube 43 to the processing chamber 15.

The remote microwave plasma system 55 is integrally located and mounted below the chamber 15 with the conduit 47 coming up alongside the chamber 15 to the gate valve 280 and the gas mixing box 273, located above the chamber 15. Microwave generator 110 and ozonator 115 may be located remote from the clean room. Supply lines 83 and 85 from the gas supply panel 80 provide reactive gases to the gas supply line 43. The gas supply panel 80 includes lines from gas or liquid sources 90 that provide the process gases for the selected application. The gas supply panel 80 has a mixing system 93 that mixes selected gases before flow to the gas mixing box 273. In some embodiments, gas mixing system 93 includes a liquid injection system for vaporizing reactant liquids such as tetraethylorthosilicate (“TEOS”), triethylborate (“TEB”), and triethylphosphate (“TEPO”). Vapor from the liquids may be combined with a carrier gas, such as helium. Supply lines for the process gases may include (i) shut-off valves 95 that can be used to automatically or manually shut off the flow of process gas into line 85 or line 57, and (ii) liquid flow meters (LFM) 100 or other types of controllers that measure the flow of gas or liquid through the supply lines.

As an example, a mixture including TEOS as a silicon source may be used with gas mixing system 93 in a deposition process for forming a silicon oxide film. The TEPO is a liquid source that may be vaporized by conventional boiler-type or bubbler-type hot boxes. However, a liquid injection system is preferred as it provides greater control of the volume of reactant liquid introduced into the gas mixing system. The liquid is typically injected as a fine spray or mist into the carrier gas flow before being delivered to a heated gas delivery line 85 to the gas mixing block and chamber. One or more sources, such as oxygen (O₂) or ozone (O₃) flow to the chamber through another gas delivery line 83, to be combined with the reactant gases from heated gas delivery line 85 near or in the chamber. Of course, it is recognized that other sources of dopants, silicon, and oxygen also may be used.

In another example, the source fluids for the etchant may be prepared in mixing system 93 and introduced into the chamber 15. This may include introducing ammonia (NH₃), nitrogen trifluoride (NF₃) and inert gases (e.g., He, N₂) to the mixing chamber 93 where the etchant is mixed. The mixture may be activated by the remote plasma system 55 to generate reactive species in the etchant before being introduced to the chamber 15. In additional embodiments, components of the etchants may be separately activated by the remote plasma system 55 (e.g., the NF₃ and/or NH₃ are independently activated) and then mixed after being introduced into the chamber 15.

B. HDP-CVD System

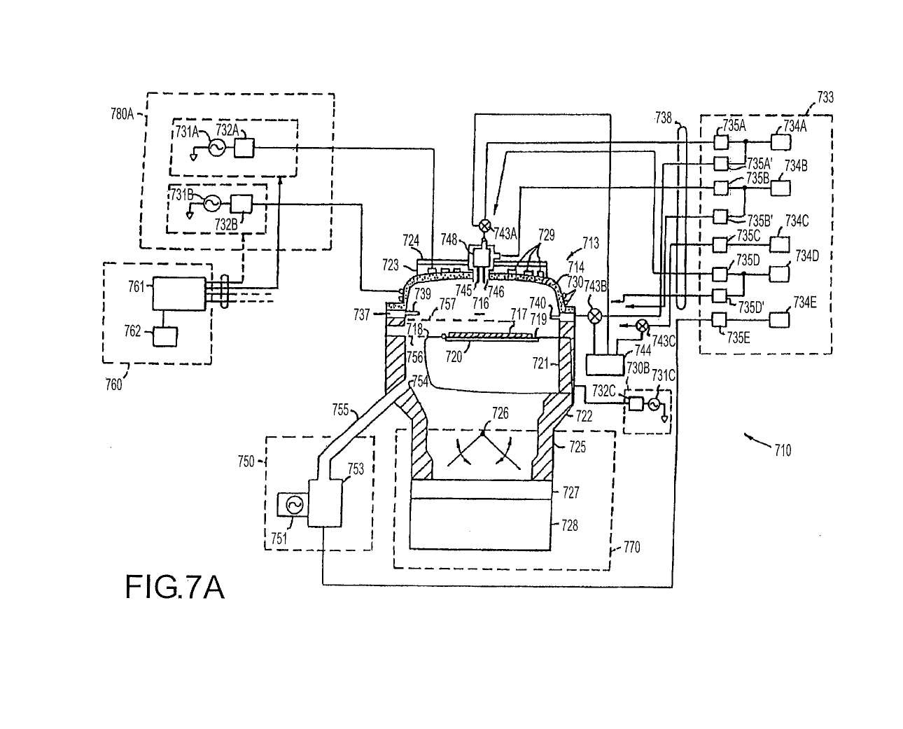

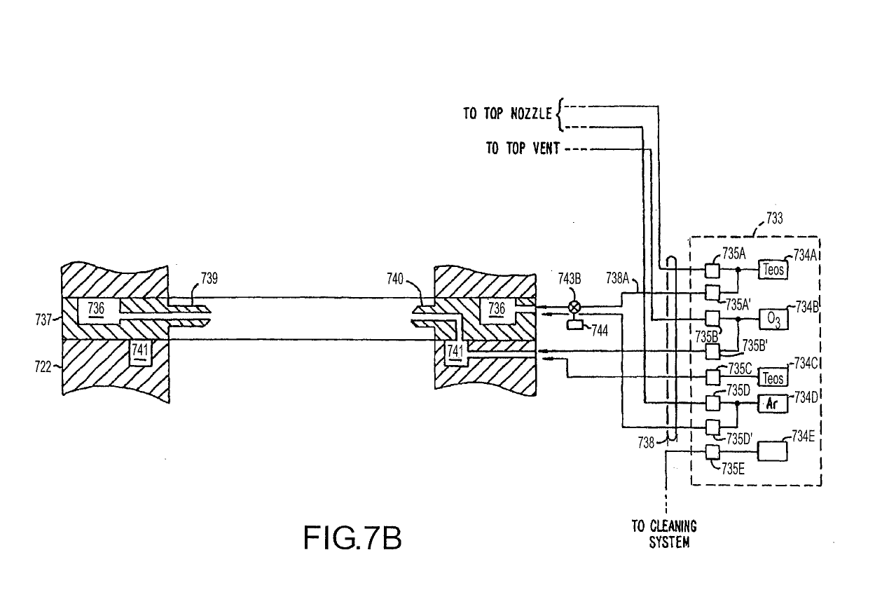

FIGS. 7A and 7B show simplified representations of a HDP-CVD system that may be used to conduct embodiments of the dep-etch-dep processes according to the invention. Aspects of this exemplary system are incorporated into commercially available HDP-CVD systems, such as models from the ULTIMA™ system line from APPLIED MATERIALS, INC. of Santa Clara, Calif. Additional details about exemplary HDP-CVD systems and their applications for dielectric gap fill processes may be found, among other places, in U.S. Pat. No. 6,740,601 to Zhengquan et al, issued May 25, 2004, and titled “HDP-CVD DEPOSITION PROCESS FOR FILING HIGH ASPECT RATIO GAPS” the entire contents of which are herein incorporated by reference for all purposes.

FIG. 7A shows a simplified a high density plasma chemical vapor deposition system 710 for depositing a dielectric material in a gap according to embodiments of the invention. The system 710 includes a chamber 713, a vacuum system 770, a source plasma system 780A, a bias plasma system 780B, a gas delivery system 733, and a remote plasma cleaning system 750. The upper portion of chamber 713 includes a dome 714, which is made of a ceramic dielectric material, such as aluminum oxide or aluminum nitride. Dome 714 defines an upper boundary of a plasma processing region 716. Plasma processing region 716 is bounded on the bottom by the upper surface of a substrate 717 and a substrate support 718.

A heater plate 723 and a cold plate 724 surmount, and are thermally coupled to, dome 714. Heater plate 723 and cold plate 724 allow control of the dome temperature to within about ±10° C. over a range of about 100° C. to about 200° C. This allows optimizing the dome temperature for the various processes. For example, it may be desirable to maintain the dome at a higher temperature for cleaning or etching processes than for deposition processes. Accurate control of the dome temperature also reduces the flake or particle counts in the chamber and improves adhesion between the deposited layer and the substrate.

Generally, exposure to the plasma heats a substrate positioned on substrate support 718. Substrate support 718 includes inner and outer passages (not shown) that can deliver a heat transfer gas (sometimes referred to as a backside cooling gas) to the backside of the substrate.

The lower portion of chamber 713 includes a body member 722, which joins the chamber to the vacuum system. A base portion 721 of substrate support 718 is mounted on, and forms a continuous inner surface with, body member 722. Substrates are transferred into and out of chamber 713 by a robot blade (not shown) through an insertion/removal opening (not shown) in the side of chamber 713. Lift pins (not shown) are raised and then lowered under the control of a motor (also not shown) to move the substrate from the robot blade at an upper loading position 757 to a lower processing position 756 in which the substrate is placed on a substrate receiving portion 719 of substrate support 718. Substrate receiving portion 719 includes an electrostatic chuck 720 that secures the substrate to substrate support 718 during substrate processing. In a preferred embodiment, substrate support 718 is made from an aluminum oxide or aluminum ceramic material.

Vacuum system 770 includes throttle body 725, which houses twin-blade throttle valve 726 and is attached to gate valve 727 and turbo-molecular pump 728. It should be noted that throttle body 725 offers minimum obstruction to gas flow, and allows symmetric pumping, as described in co-pending, co-assigned U.S. patent application Ser. No. 08/574,839, filed Dec. 12, 1995, and which is incorporated herein by reference. Gate valve 727 can isolate pump 728 from throttle body 725, and can also control chamber pressure by restricting the exhaust flow capacity when throttle valve 726 is fully open. The arrangement of the throttle valve, gate valve, and turbo-molecular pump allow accurate and stable control of chamber pressures from between about 1 mTorr to about 2 Torr.

The source plasma system 780A includes a top coil 729 and side coil 730, mounted on dome 714. A symmetrical ground shield (not shown) reduces electrical coupling between the coils. Top coil 729 is powered by top source RF (SRF) generator 731A, whereas side coil 730 is powered by side SRF generator 731B, allowing independent power levels and frequencies of operation for each coil. This dual coil system allows control of the radial ion density in chamber 713, thereby improving plasma uniformity. Side coil 730 and top coil 729 are typically inductively driven, which does not require a complimentary electrode. In a specific embodiment, the top source RF generator 731A provides up to 2,500 watts of RF power at nominally 2 MHz and the side source RF generator 731B provides up to 5,000 watts of RF power at nominally 2 MHz. The operating frequencies of the top and side RF generators may be offset from the nominal operating frequency (e.g., to 1.7-1.9 MHz and 1.9-2.1 MHz, respectively) to improve plasma-generation efficiency.

A bias plasma system 780B includes a bias RF (BRF) generator 731C and a bias matching network 732C. The bias plasma system 780B capacitively couples substrate portion 717 to body member 722, which act as complimentary electrodes. The bias plasma system 780B serves to enhance the transport of plasma species (e.g., ions) created by the source plasma system 780A to the surface of the substrate. In a specific embodiment, bias RF generator provides up to 5,000 watts of RF power at 13.56 MHz.

RF generators 731A and 731B include digitally controlled synthesizers and operate over a frequency range between about 1.8 to about 2.1 MHz. Each generator includes an RF control circuit (not shown) that measures reflected power from the chamber and coil back to the generator and adjusts the frequency of operation to obtain the lowest reflected power, as understood by a person of ordinary skill in the art. RF generators are typically designed to operate into a load with a characteristic impedance of 50 ohms. RF power may be reflected from loads that have a different characteristic impedance than the generator. This can reduce power transferred to the load. Additionally, power reflected from the load back to the generator may overload and damage the generator. Because the impedance of a plasma may range from less than 5 ohms to over 900 ohms, depending on the plasma ion density, among other factors, and because reflected power may be a function of frequency, adjusting the generator frequency according to the reflected power increases the power transferred from the RF generator to the plasma and protects the generator. Another way to reduce reflected power and improve efficiency is with a matching network.

Matching networks 732A and 732B match the output impedance of generators 731A and 731B with their respective coils 729 and 730. The RF control circuit may tune both matching networks by changing the value of capacitors within the matching networks to match the generator to the load as the load changes. The RF control circuit may tune a matching network when the power reflected from the load back to the generator exceeds a certain limit. One way to provide a constant match, and effectively disable the RF control circuit from tuning the matching network, is to set the reflected power limit above any expected value of reflected power. This may help stabilize a plasma under some conditions by holding the matching network constant at its most recent condition. Other measures may also help stabilize a plasma. For example, the RF control circuit can be used to determine the power delivered to the load (plasma) and may increase or decrease the generator output power to keep the delivered power substantially constant during deposition of a layer.

A gas delivery system 733 provides gases from several sources, 734A-734F chamber for processing the substrate via gas delivery lines 738 (only some of which are shown). As would be understood by a person of skill in the art, the actual sources used for sources 734A-734F and the actual connection of delivery lines 738 to chamber 713 varies depending on the deposition and cleaning processes executed within chamber 713. Gases are introduced into chamber 713 through a gas ring 737 and/or a top nozzle 745. FIG. 7B is a simplified, partial cross-sectional view of chamber 713 showing additional details of gas ring 737.

In one embodiment, first and second gas sources, 734A and 734B, and first and second gas flow controllers, 735A′ and 735B′, provide gas to ring plenum 736 in gas ring 737 via gas delivery lines 738 (only some of which are shown). Gas ring 737 has a plurality of gas nozzles 739 (only one of which is shown for purposes of illustration) that provides a uniform flow of gas over the substrate. Nozzle length and nozzle angle may be changed to allow tailoring of the uniformity profile and gas utilization efficiency for a particular process within an individual chamber. In a preferred embodiment, gas ring 737 has 12 gas nozzles 739 made from an aluminum oxide ceramic.

Gas ring 737 also has a plurality of gas nozzles 740 (only one of which is shown), which in a preferred embodiment are co-planar with and shorter than source gas nozzles 739, and in one embodiment receive gas from body plenum 741. Gas nozzles 739 and 740 are not fluidly coupled in some embodiments it is desirable not to mix gases before injecting the gases into chamber 713. In other embodiments, gases may be mixed prior to injecting the gases into chamber 713 by providing apertures (not shown) between body plenum 741 and gas ring plenum 736. In one embodiment, third and fourth gas sources, 734C and 734D, and third and fourth gas flow controllers, 735C′ and 735D′, provide gas to body plenum via gas delivery lines 738. Additional valves, such as 743B (other valves not shown), may shut off gas from the flow controllers to the chamber.

In embodiments where flammable, toxic, or corrosive gases are used, it may be desirable to eliminate gas remaining in the gas delivery lines after a deposition. This may be accomplished using a 3-way valve, such as valve 743B, to isolate chamber 713 from delivery line 738A and to vent delivery line 78A to vacuum foreline 744, for example. As shown in FIG. 7A, other similar valves, such as 743A and 743C, may be incorporated on other gas delivery lines. Such 3-way valves may be placed as close to chamber 713 as practical, to minimize the volume of the unvented gas delivery line (between the 3-way valve and the chamber). Additionally, two-way (on-off) valves (not shown) may be placed between a mass flow controller (“MFC”) and the chamber or between a gas source and an MFC.

Referring again to FIG. 7A, chamber 713 also has top nozzle 745 and top vent 746. Top nozzle 745 and top vent 746 allow independent control of top and side flows of the gases, which improves film uniformity and allows fine adjustment of the film's deposition and doping parameters. Top vent 746 is an annular opening around top nozzle 745. In one embodiment, first gas source 734A supplies source gas nozzles 739 and top nozzle 745. Source nozzle MFC 735A′ controls the amount of gas delivered to source gas nozzles 739 and top nozzle MFC 735A controls the amount of gas delivered to top gas nozzle 745. Similarly, two MFCs 735B and 735B′ may be used to control the flow of oxygen to both top vent 746 and oxidizer gas nozzles 740 from a single source of oxygen, such as source 734B. The gases supplied to top nozzle 745 and top vent 746 may be kept separate prior to flowing the gases into chamber 713, or the gases may be mixed in top plenum 748 before they flow into chamber 713. Separate sources of the same gas may be used to supply various portions of the chamber.

A remote microwave-generated plasma cleaning system 750 may be provided to activate deposition and etchant gas mixture as well as periodically clean deposition residues from chamber components. The cleaning system includes a remote microwave generator 751 that creates a plasma from a cleaning and/or etchant gas source 734E (e.g., molecular fluorine, nitrogen trifluoride, other fluorocarbons or equivalents) in reactor cavity 753. The reactive species resulting from this plasma are conveyed to chamber 713 through cleaning gas feed port 754 via applicator tube 755. The materials used to contain the cleaning plasma (e.g., cavity 753 and applicator tube 755) must be resistant to attack by the plasma. The distance between reactor cavity 753 and feed port 754 may be kept short to reduce their deactivation before they reach the reactor cavity 753. Activating the cleaning plasma and etchant in a remote cavity allows the use of an efficient microwave generator and does not subject chamber components to the temperature, radiation, or bombardment of the glow discharge that may be present in a plasma formed in situ. Consequently, relatively sensitive components, such as electrostatic chuck 720, do not need to be covered with a dummy wafer or otherwise protected, as may be required with an in situ plasma cleaning process.

System controller 760 controls the operation of system 710. In a preferred embodiment, controller 760 includes a memory 762, such as a hard disk drive, a floppy disk drive (not shown), and a card rack (not shown) coupled to a processor 761. The card rack may contain a single-board computer (SBC) (not shown), analog and digital input/output boards (not shown), interface boards (not shown), and stepper motor controller boards (not shown). The system controller conforms to the Versa Modular European (VME) standard, which defines board, card cage, and connector dimensions and types. The VME standard also defines the bus structure as having a 16-bit data bus and 24-bit address bus. System controller 731 operates under the control of a computer program stored on the hard disk drive or through other computer programs, such as programs stored on a removable disk. The computer program dictates, for example, the timing, mixture of gases, RF power levels and other parameters of a particular process.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

As used herein and in the appended claims, the singular forms “a”, “and”, and “the” include plural referents unless the context clearly dictates otherwise. Thus, for example, reference to “a process” includes a plurality of such processes and reference to “the etchant” includes reference to one or more etchants and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, or groups.

What is claimed is:

1. A method of forming a dielectric material in a substrate gap using a high-density plasma, the method comprising:
depositing a first portion of the dielectric material into the gap with the high-density plasma;
exposing the first portion of dielectric material to an etchant comprising reactive species from a mixture that includes NH₃ and NF₃; and
depositing a final portion of the dielectric material in the gap with the high-density plasma.

2. The method of claim 1, wherein the mixture that includes NH₃ and NF₃ includes flowing together separate sources of NH₃ and NF₃, and wherein a flow rate ratio of NH₃:NF₃ is about 2:1 or more.

3. The method of claim 2, wherein the flow rate ratio of NH₃:NF₃ is about 8:1 or more.

4. The method of claim 1, wherein the reactive species comprises a fluorine radical.

5. The method of claim 1, wherein at least a portion of the reactive species are created in a plasma that is generated from the mixture that includes NH₃ and NF₃.

6. The method of claim 5, wherein the plasma is remotely generated outside a chamber where the etchant is exposed to the first portion of the dielectric material.

7. The method of claim 1, wherein the etchant reacts to form a solid reaction product from a protruding structure of the dielectric material that at least partially blocks the deposition of additional dielectric material into the gap.

8. The method of claim 7, wherein the solid reaction product is removed from the substrate by heating the reaction product to convert it into a gas phase.

9. The method of claim 1, wherein the first and the final portions of dielectric material are deposited by exposing the gap to a silicon containing precursor and an oxygen containing precursor.

10. The method of claim 7, wherein the silicon containing precursor comprises TEOS and the oxygen containing precursor comprises ozone.

11. The method of claim 1, wherein the dielectric material comprises silicon oxide.

12. The method of claim 1, wherein the high-density plasma has an electron density of about 10¹¹ to 10¹³ cm⁻³ and an ionized gas fraction of about 0.001 to 0.1.

13. The method of claim 1, wherein the depositing steps and the exposing step are performed in a single reaction chamber.

14. A method of forming a dielectric material in a substrate gap using a high-density plasma, the method comprising:
depositing a first portion of the dielectric material into the gap with the high-density plasma, wherein the deposition forms a protruding structure that at least partially blocks the deposition of the dielectric material into the gap;
exposing the first portion of dielectric material to an etchant comprising reactive species from a mixture that includes NH₃ and NF₃, wherein the etchant forms a solid reaction product with the protruding structure;
removing the solid reaction product from the substrate; and
depositing a final portion of the dielectric material in the gap with the high-density plasma.

15. The method of claim 14, wherein the mixture that includes NH₃ and NF₃ includes flowing together separate sources of NH₃ and NF₃, and wherein a flow rate ratio of NH₃:NF₃ is about 2:1 or more.

16. The method of claim 14, wherein at least a portion of the reactive species are created in a plasma that is generated from the mixture that includes NH₃ and NF₃.

17. The method of claim 14, wherein the plasma is remotely generated outside a chamber where the etchant is exposed to the first portion of the dielectric material.

18. The method of claim 14, wherein the solid reaction product is removed by heating the reaction product to convert it to a gas phase.

19. The method of claim 18, wherein the solid reaction product is heated to a temperature of at least 100° C.

20. A method of forming a dielectric material on a substrate using a high-density plasma, the method comprising:
depositing a first portion of the dielectric material into a gap on the substrate with the high-density plasma in a HDPCVD chamber, wherein the deposition forms a protruding structure that at least partially blocks the deposition of the dielectric material into the gap;
transferring the substrate to an etching chamber and exposing the first portion of dielectric material to an etchant comprising reactive species from a mixture that includes NH₃ and NF₃, wherein the etchant forms a solid reaction product with the protruding structure;
removing the solid reaction product from the substrate; and
transferring the substrate back to the HDPCVD chamber and depositing a final portion of the dielectric material in the gap with the high-density plasma.
